(19) United States
(12) Patent Application Publication
(10) Pub. No.: US 2012/0215847 A1
(43) Pub. Date: Aug. 23, 2012

(54) METHOD FOR PROVIDING DIARY-BASED SOCIAL NETWORK SERVICE AND SYSTEM USING THE SAME

(75) Inventors: Mingu Cho, Incheon (KR); Yanghee Choi, Seoul (KR); Jinyoung Han, Seoul (KR); Wonyoung Kwak, Gyeonggi-do (KR); Taekyoung Kwon, Seoul (KR); Jihoon Lee, Gyeonggi-do (KR)

(73) Assignee: SNU R&DB Foundation, Gwanak-gu, Seoul (KR)

(21) Appl. No.: 13/203,114

(22) PCT Filed: May 25, 2011
(86) PCT No.: PCT/KR11/03820

§ 371 Date: Nov. 21, 2011

(30) Foreign Application Priority Data
Feb. 18, 2011 (KR) 2011-0014382

(51) Int. Cl. G06F 15/16

(52) U.S. Cl. 709/204

(57) ABSTRACT

The present invention relates to a method for providing Social Network Service (SNS) on the Internet and a system using the same. The present invention is characterized by creating a user tag list constructed with tags that are acquired by a user terminal; forming a social network between the user and other users, based on tags of the user tag list; and creating a diary based on the user tag list and social network associated with tags of the user tag list.

While the present invention enables a user to create a diary about one's own life, the present invention provides a social network service (SNS) by utilizing tagging information in the created diary to form a new social network with people or specialists who have the same interests.

### TECHNICAL FIELD

The present invention relates to a method for providing a social network service (SNS) on the Internet and a system using the same, and more particularly, to a method and system for providing SNS based on a diary created by using tags.

### BACKGROUND ART

The initial Internet had been used for the purpose of searching and sharing information. People had exchanged necessary information via e-mail, messenger, and the like, and received information from various portal sites or service providers. However, as the use of Internet has increased with the improvement of techniques, people have gradually become interested in expressing their own opinions, areas of interest, and the like. In particular, people who have the same interests had made societies/clubs/internet cafés, and the like, to share their areas of interests, and developing therefrom, the people had started to make their own personal websites to introduce themselves.

Meanwhile, general Internet users have difficulty making their own personal websites and have encountered a certain entry barrier in making their personal websites. However, as Internet users have continuously increased regardless of ages and sexes, the Internet users have increasingly desired to make their personal websites as spaces for expressing themselves through the Internet.

In the middle of 2000, with the increase of such desire, various services for providing personal websites have been introduced. The services have provided frames in which Internet users can easily make their personal websites and post pictures or messages, and the like. Such frames have posed low technical difficulties to the internet users compared to the previous works for making personal websites. Along with such services, Social Network Service (SNS) for sharing personal contents posted on the Internet with relations (personal connections) formed on the Internet services is provided, resulting in explosively increasing demands for the SNS. The SNS has changed the Internet, which only served as a field of information exchange, to a means for meeting personal desires to form a new relationship with other people and to introduce themselves in cyber space. As representative examples of such services, there are Cyworld in Korea and Myspace in the world.

Recently, while many mobile devices such as smartphones have been distributed, new services for expressing their own opinions or personal life in real time have been created. As people could easily access networks anytime and anywhere through mobile devices without using a PC, it has become possible to share their own life with other people in real time without location and time constraints. In addition, the conventional services were provided to make a relationship mainly with people who have a direct relationship, whereas new services are provided to exchange information even among people who have no relationship through the Internet. This has resulted in creating horizontal relationships that break down social boundaries on the Internet. For example, through new real-time SNS, celebrities can promote their own or their companies' products, and public institutions can publicize significant information. As representative examples of such services, there are Me2day in Korea and Twitter, Facebook, etc. overseas. DETAILED DESCRIPTION OF THE INVENTION

### Problems to be Solved

Most of people may agree that the services, which have been developed as described above, help them express themselves or make a social relationship on the Internet, have had considerable ripple effects on the social community, and have brought significant changes to society. The main basis of such services is a desire to express oneself or one's own opinions on the Internet and a desire to exchange information and opinions with various people on the Internet. However, up to date, the current services support the two desires separately.

To be specific, a social relationship on the Internet is formed based on personal interests; to this end, an Internet user has to search for people who have the same interests one by one, and can form a relationship only with certain people based on such a passive process. Since making a social relationship in such manner takes a lot of time and efforts, many Internet users do not bother and have missed benefits that could otherwise be obtained by forming a relationship with people related to themselves.

Therefore, the present invention provides a system supporting the two desires (expressing oneself and making a social relationship) people seek on the Internet. According to the present invention, high-technology mobile devices such as generalized smartphones can be used to create a diary about their own life and to make a social relationship immediately based on information in the diary. Herein, the information in the diary may include time, places, personal interests, and the like.

### Technical Means for Solving the Problems

According to the present invention, a method for providing a diary-based social network service (SNS) comprises: creating a user tag list constructed with tags that are acquired by a user terminal; forming a social network between a user and other users, based on tags of the user tag list; and creating a diary based on the user tag list and the social network associated with tags of the user tag list.

In one embodiment according to the present invention, the method for providing a diary-based social network service (SNS) may further comprise: receiving a request to use diary-based SNS from the user terminal to create the user tag list, wherein said receiving a request to use the diary-based SNS may comprise: receiving a user profile from the user terminal and may further comprises: storing the user profile in a user information database.

In another embodiment according to the present invention, said creating a user tag list may further comprise: receiving a present location of the user terminal from the user terminal periodically; and acquiring tags classified by time and locations associated with routes of the user terminal and user profiles.

In another embodiment according to the present invention, said creating a user tag list may further comprise: storing the user tag list in a user information database.

In another embodiment according to the present invention, said forming a social network may further comprise: determining whether there is a user recommended by an administrator concerning tags of the user tag list; forming a social network between the user and the recommended user, if there is a recommended user; and forming a social network between the user and the searched user with the highest credibility on the tag, if there is no recommended user.

In another embodiment according to the present invention, said forming a social network may further comprise: storing social network information on the user tag list in a user information database.

In another embodiment according to the present invention, said creating a diary may comprise determining whether there is a social network associated with a tag of the user tag list; if there is an associated social network, acquiring contents from a user of the associated social network; recommending discovered contents through Internet search on tags of the user tag list if there is no associated social network, and acquiring the contents selected by the user; and linking the acquired contents to the tag of the user tag list.

According to the present invention, a system for providing a diary-based social network service (SNS) comprises: a user terminal in which an application for a diary-based SNS is installed; a tag collecting server creating a user tag list from tags acquired by the user terminal; an SNS server forming a social network between a user and other users by searching through tag databases, based on the user tag list; a diary agent communicating with the user terminal, the tag collecting server, the SNS server and the user tag list, to create a diary; and a user information database storing the user tag list, social network information and diary.

In one embodiment according to the present invention, the diary agent of the system may be further configured to: receive a request to use SNS from the user terminal; receive a user profile from the user terminal; and store the user profile in the user information database.

In another embodiment according to the present invention, the tag collecting server may be further configured to: receive a present location of the user terminal from the user terminal periodically; and acquire tags classified by time and locations associated with routes of the user terminal.

In another embodiment according to the present invention, the SNS server may be further configured to: form a social network with a user recommended by an administrator concerning tags of the user tag list, based on a search of the tag database.

In another embodiment according to the present invention, the tag database may be further configured to: store credibility of each user on tags; and the SNS server may be further configured to: form a social network with a user with the highest credibility on a tag of the user tag list, based on a search of the user tag list.

In another embodiment according to the present invention, the diary agent of the system may be further configured to: determine whether there is a social network associated with tags of the user tag list; acquire contents from a user of the social network if there is an associated social network; recommend contents discovered through the interne search on a tag of the user tag list if there is no associated social network, and acquire the contents selected by the user; and link the acquired contents with tags of the user tag list.

According to the present invention, in a system for providing a diary-based social network service (SNS), an apparatus for forming a social network between a user and other users based on a user tag list comprises: means for determining whether there is a user recommended by an administrator concerning tags of the user tag list; means for forming a social network between the user and the recommended user if there is a recommended user; and means for forming a social network between the user and the searched user with the highest credibility on a tag, if there is no recommended social network.

According to the present invention, in a system for providing a diary-based social network service (SNS), an apparatus for creating a diary based on a user tag list and social network information associated with tags of the user tag list, comprises: means for determining whether there is a social network associated with a tag of the user tag list; means for acquiring contents from a user of the social network if there is an associated social network; means for recommending contents discovered through the Internet search on a tag of the user tag list if there is no associated social network, and acquiring contents selected by the user; and means for linking the acquired contents to tags of the user tag list.

### Effects of the Invention

The method for providing a diary-based social network service (SNS) according to the present invention enables a user to create a diary about his own life in order to meet a desire to express himself. In addition, the present invention provides a social network service (SNS) by utilizing information in the created diary, such as on location, time and thing/people, and tagging information associated with personal interests, not only to share a diary with friends but also to form a new social network with people or specialists who have the same interests through the created diary.

### BRIEF DESCRIPTION OF DRAWINGS

FIG. 1. shows a schematic diagram of a system using a method for providing a diary-based social network service (SNS) according to the present invention.

FIG. 2 shows a flow chart for a method for providing a diary-based social network service (SNS) according to the present invention.

FIG. 3 shows a flow chart for a process of receiving a request to use diary-based SNS in a method for providing a diary-based social network service (SNS) according to the present invention.

FIG. 4 shows a flow chart for a process of creating a user tag list in a method for providing a diary-based social network service (SNS) according to the present invention.

FIG. 5 shows a flow chart for a process of forming a social network based on the user tag list in a method for providing a diary-based social network service (SNS) according to the present invention.

FIG. 6 shows a flow chart for illustrating another embodiment for a process of forming a social network based on a user tag list in a method for providing a diary-based social network service (SNS) according to the present invention.

FIG. 7 shows a flow chart for a process of creating a diary based on a user tag list and social network associated with tags of the user tag list in a method for providing a diary-based social network service (SNS) according to the present invention.

### BEST MODES FOR CARRYING OUT THE INVENTION

The present invention is to create a diary about one's own life and provide a social network service (SNS) by utilizing information in the diary, such as on location, time and products/people, and tagging information associated with personal interests. This is not only to share the diary with friends but also to form a new social network with people associated with the tagging information in the diary.

To this end, according to the present invention, tags are assigned to regions and things/people, and a user receives SNS by creating a diary based on the tags, wherein the diary is created utilizing content (e.g., texts, images, voices/videos) acquired from the Internet or people with whom a social relationship is formed.

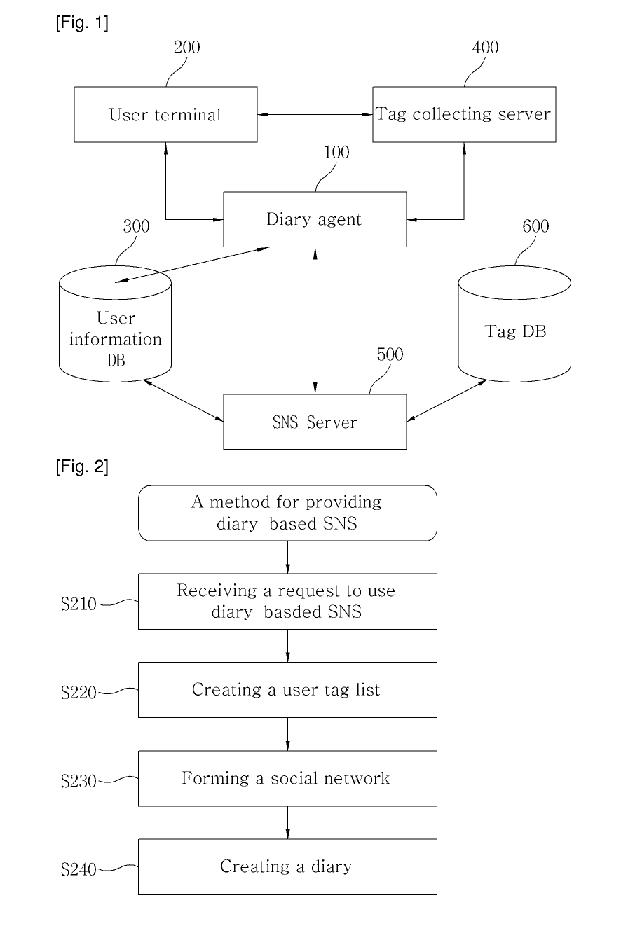

FIG. 1. shows a configuration of a system using a method for providing a diary-based social network service (SNS).

The system using the method for providing a diary-based social network service (SNS) according to the present invention comprises, for example, the following elements.

A diary agent (100) receives a request to use diary-based SNS from a user terminal (200) in which an application for the diary-based SNS is installed; receives a profile from a user; sends the user profile to a user information database (DB; 300); and stores the user profile in the user information DB (300). Then, the diary agent (100) communicates with a tag collecting server (400) to create a user tag list. The created user tag list is stored in the user information DB (300).

In addition, the diary agent (100) requests an SNS server (500) to form a social network, and in response to the request, the SNS server (500) forms a social network between the user and other users based on the user tag list. To this end, the SNS server (500) computes credibility, similarity and intimacy based on a tag database (DB; 600) to form a social network. The tag DB (600) also retains users' credibility on tags. The SNS server (500) stores social network information on the user tag list in the user information DB (300).

When the above processes are all completed, the diary agent (100) finally creates a diary based on the user tag list and the social network information thereof stored in the user information DB (300), and the finally created diary is re-stored in the user information DB (300).

Hereinafter, with reference to FIG. 2 showing the overall process of the method for providing a diary-based social network service (SNS), the method for providing a diary-based social network service (SNS) will be described in detail.

First, the diary agent receives a request to use diary-based SNS from a user (S210), and in response to the request, the diary agent creates a user tag list constructed by tags acquired by the user terminal (S220). The SNS server forms a social network with other users based on tags of the created user tag list (S230). Finally, the diary agent creates a diary based on the social network associated with the tags of the user tag list (S240).

The method for providing a diary-based social network service (SNS) according to the present invention may be performed by, for example, the system of FIG. 1. To be specific, the diary agent (100) may receive a request to use diary-based SNS from a user terminal (200), and in response to the request, create a user tag list. The user tag list may be created by the tag collecting server (400) and stored in the user information DB (300). After then, when the SNS server (500) forms a social network based on the user tag list in response to the request of the diary agent (100), the diary agent (100) may create a diary based on the created social network.

The method for providing a diary-based social network service (SNS) according to the present invention is not limited to the system illustrated in FIG. 1, and there are various systems for performing the method for providing a diary-based social network service (SNS) according to the present invention.

For example, a user terminal (200) may be a portable wireless device (e.g., a cellular phone, PDA, a smartphone), a notebook PC, a typical PC, and the like.

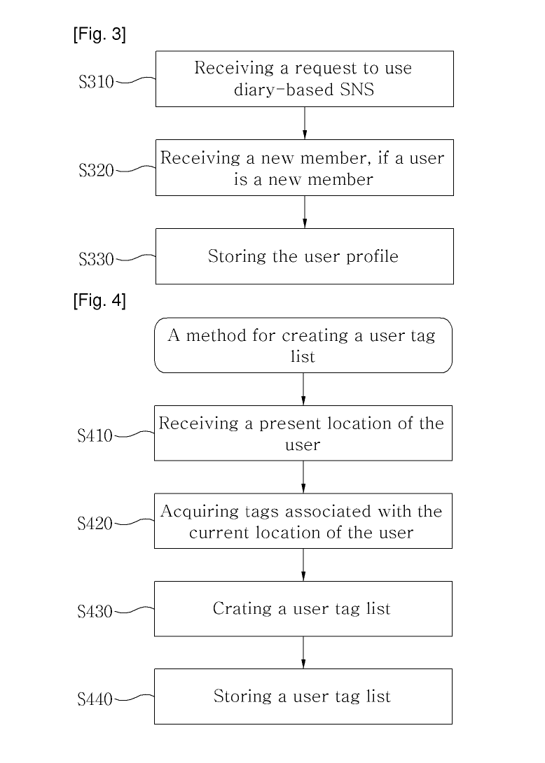

Hereinafter, with reference to FIG. 3, the process of receiving a request to use diary-based SNS will be described in detail.

First, the diary agent (100) receives a request to use diary-based SNS from the user terminal (200) (S310). Here, a user may directly operate the user terminal (200) to send the request, or the user or an administrator may set the user terminal (200) or diary agent (100) to automatically send the request to use the SNS periodically (e.g., daily, weekly).

If a user is a new member, a process for receiving the new member proceeds, wherein the diary agent (100) may receive a profile on the user from the user terminal (200) (S320), and store the received user profile in the user information DB (300) for the user joining the diary based SNS (S330). Meanwhile, if a user who requests to use a diary-based SNS has already been a member, just receiving a request for use from the user terminal would start the diary creating process.

Now, the process of creating a user tag list will be described in detail with reference to FIG. 4.

The user terminal (for example, a portable wireless device of a user) sends present location information to the tag collecting server (400) periodically (S410). The location of the user terminal may be estimated based on information collected from various systems.

One of the systems may include GPS (Global Positioning System), which is one of SPSs (satellite positioning systems), and a location information system, which uses base station information of a user terminal. The tag collecting server (400) that receives the present location information of the user terminal acquires tags classified by time and locations associated with routes of the user terminal time and locations (S420), and creates a user tag list including the acquired tags (S430). Thereafter, the tag collecting server (400) stores the user tag list in the user information DB (300) (S440).

In another embodiment, the tag collecting server (400) may acquire tags according to time and locations of a user and send the acquired tags to the diary agent (100).

The diary agent may create a user tag list by combining the received tags and store the created user tag list in the user information DB (300).

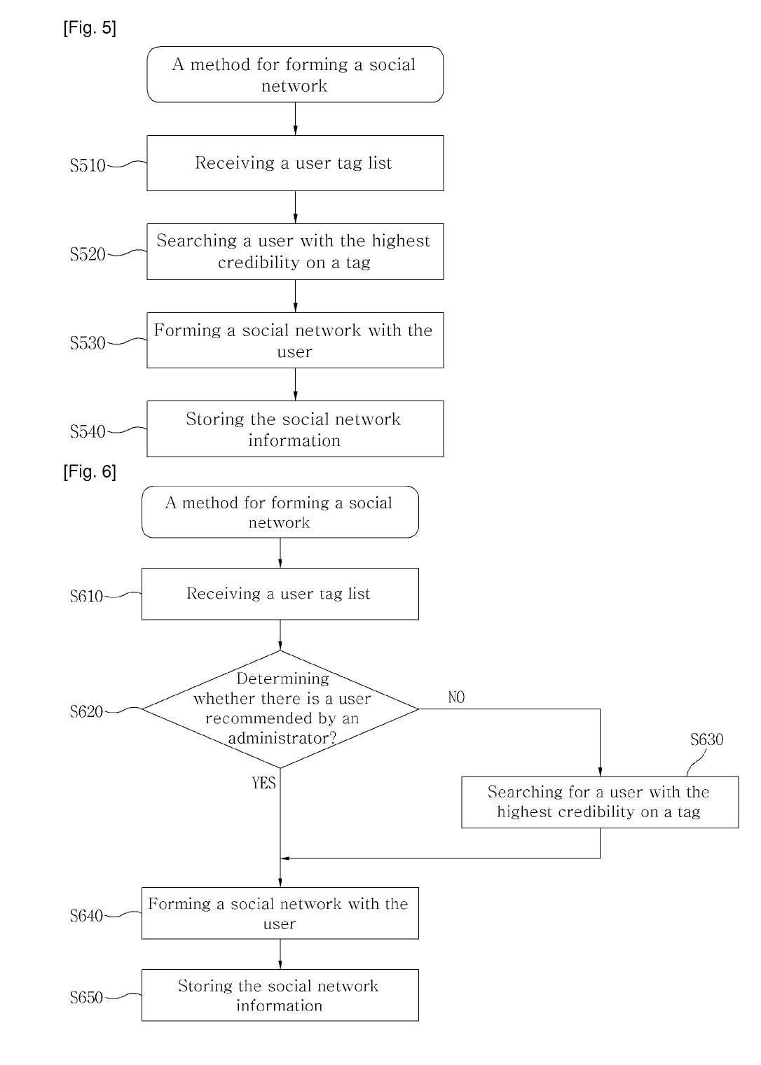

With reference to FIG. 5, the process of forming a social network based on a user tag list will be described.

The SNS server (500) that receives a request to form a social network based on a user tag list from the diary agent (100) receives the user tag list from the user information DB (300) (S510). The SNS server (500) searches through the tag DB (600) with tags of the user tag list. The SNS server (500) discovers other users with the highest credibility on a tag through the search of the tag DB (600) (S520), and forms a social network between the user and the discovered other users (S530).

Through the above process, it is possible not only to form a social network with acquaintances but also to form a social network with other users from whom specialized information can be obtained. Finally, the SNS server (500) stores the social network information on the user tag list in the user information DB (300).

In another embodiment, it may enable a user to decide whether the SNS server (500) automatically forms a social network with other users. And, if the user allows the SNS server to automatically form a social network, the SNS server (500) may automatically form a social network with the searched user with high credibility through the search of the tag DB (600), and if the user does not allow the SNS server to automatically form a social network, the SNS server (500) may recommend forming a social network with the discovered user to the user.

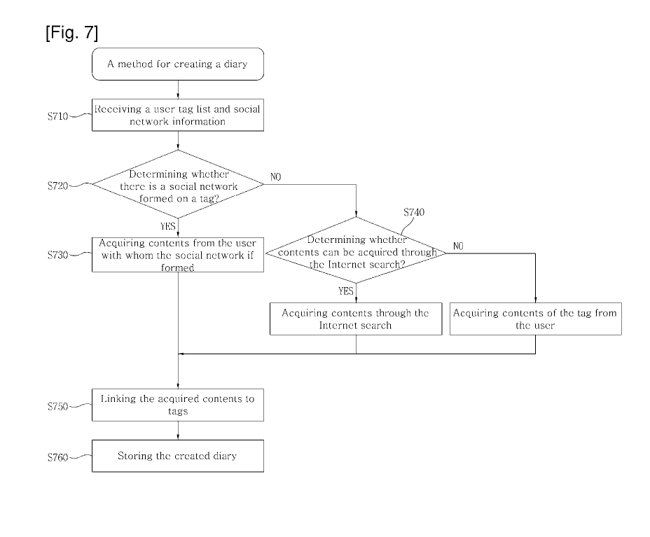

Now, with reference to FIG. 6, another embodiment for the process of forming a social network with other users will be described.

While the SNS server (500) searches through the tag DB (600) (S610), the SNS server (500) determines whether there is a user recommended by an administrator concerning tags (S620). If a recommended user does not exist, as illustrated in the embodiment above, the SNS server may search for a user with the highest credibility on the tag (S630), and form a social network with the searched user through the search (S640).

However, if there is a user recommended by an administrator, the SNS server may form a social network with the user recommended by the administrator (S640). Similarly, the SNS server (500) stores social network information on the user tag list in the user information DB (300).

Herein, the recommended user is set by an administrator as a user representing a region associated with a tag.

In addition, the SNS server (500) may be configured to automatically form a social network as described above; however, the SNS server may be also configured to provide lists of searched or recommended users to a user to recommend forming a social network with the searched or found user to the user and to allow the user to approve whether to form a social network with one or more users from the lists.

Meanwhile, the credibility of each user on a tag may be computed based on a corresponding user profile stored in the user information DB (300); however, it is not limited to this embodiment, and it is also possible to set the credibility of a user on the tag with numerical values by various methods.

If a social network is formed with other users based on the user tag list, a diary can be created based on the social network, and the detailed process thereof will be described with reference to FIG. 7.

If the forming of the social network associated with the user tag list is completed by the SNS server (500), the diary agent (100) links content (e.g., texts, images, voices/videos) to each tag of the user tag list to create a diary.

To this end, the diary agent (100) first receives the user tag list and the social network information thereon from the user information DB (300) (S710).

The diary agent determines whether there is a social network associated with tags of the user tag list (S720), and acquires content from other users with whom the social network is formed if there is an associated social network (S730). If no associated social network exists, the diary agent (100) may recommend content discovered through the Internet search on a tag to the user, and the user may select and acquire one from the recommended content (S740). Thereafter, the diary agent may link the acquired content to tags to create a diary (S750), and store the created diary in the user information DB (300) to share the entire diary or the content for each tag with other users (S760).

In another embodiment, a user may link content that the user himself creates on a tag to create a diary, and thereby the user can ensure the unique content of an individual user in the field associated with tags.

Hereinafter, through a detailed example in the field of tourism, the method for providing a diary-based social network according to the present invention will be described.

### EXAMPLE 1

20-year-old university student John goes on a trip to Jeju Island on Christmas Eve, Dec. 24, 2011. John and his girlfriend departed from the Kimpo airport by airplane in the morning and arrived at Jeju airport. And then, they rent a car at the Jeju branch of a rental car company Rent Car, and took a trip to Sungsan-Ilchulbong. Thereafter, they ate dinner at a restaurant Jeju Diner and they flew back to Seoul.

Based on the itinerary above, tag information on John's locations at each time is collected, and a user tag list on Dec. 24, 2011 is created. And then, based on the created user tag list, a diary can be created as below:

First, in case of linking content concerning Kimpo airport through the tag, Kimpo airport, which is included in the user tag list as the departure point for his trip, the diary agent first searches the tag DB for Kimpo airport, forms a social network between the user and the Kimpo airport administration office on the Kimpo airport tag since there is a user that is the Kimpo airport administration office recommended by an administrator on the tag, and links an image of Kimpo airport which the Kimpo airport administration office has to a diary.

Similarly, for the Jeju airport tag, through the same process as the Kimpo airport tag, a social network is formed with the Jeju airport administration office, and the flight schedule of Dec. 24, 2011 which the Jeju airport administration office has is linked to the diary.

Meanwhile, for the tag, the Jeju branch of Rent Car, a user recommended by the administrator does not exists; however, Paul, who works as an assistant manager at the Jeju branch of Rent Car is retrieved as a user with the highest credibility, so the SNS server forms a social network between the user and Paul, and links the status of rental cars of Rent Car that Paul has to the diary.

For Sungsan-Ilchulbong, if information on the corresponding tags has not been found even through the above two processes, an Internet search on Sungsan-Ilchulbong is performed, and tourism information on Sungsan-Ilchulbong is linked to the diary in a text form based on the search.

Last, for the restaurant Jeju Diner, let us assume that no information could be obtained through the three processes. John directly takes pictures of and writes about the restaurant and its foods for the diary. Then, the restaurant is assigned a new tag.

Paul's diary of Dec. 24, 2001 created through the above process is classified as a Jeju island trip or other trip tag, and stored in the user information DB, and the stored diary can be published and shared with other users. When another user visits Jeju Diner, that user may form a social network with Paul, and Paul's pictures and writing may be linked to the diary of the user.

The detailed descriptions illustrate, explain, and describe the features of the present invention as applied in the various embodiments. However, it is apparent to those skilled in the art that various alternatives, modifications and variations in details and forms of the exemplified apparatus or processes can be made without departing from the scope of the invention. In addition, since some features can be used or carried out separately from the other features, the present invention can be implemented not to include all the features provided herein. The scope of the present disclosure is defined by the appended claims and the description described above, and the present invention covers changes of this invention provided they come within the scope of the appended claims and their equivalents.

### REFERENCE NUMERICAL NUMBERS

100: diary agent 200: user terminal

300: user information DB 400: tag collecting server

500: SNS server 600: tag DB

1. A method for providing a diary-based social network service (SNS), comprising;
creating a user tag list constructed with tags that are acquired by a user terminal;
forming a social network between a user and other users, based on tags of the user tag list; and
creating a diary based on the user tag list and the social network associated with tags of the user tag list.

2. The method of claim 1, further comprising: receiving a request to use diary-based SNS from the user terminal to create the user tag list.

3. The method of claim 2, wherein said receiving a request to use the diary-based SNS comprises: receiving a user profile from the user terminal.

4. The method of claim 2, wherein said receiving a request to use the diary-based SNS further comprises: storing the user profile in a user information database.

5. The method of claim 1, wherein said creating a user tag list comprises:
receiving a present location of the user terminal from the user terminal periodically; and
acquiring tags classified by time and locations associated with routes of the user terminal and user profiles.

6. The method of claim 1, wherein said creating a user tag list further comprises storing the user tag list in a user information database.

7. The method of claim 1, wherein said forming a social network comprises:
searching for a user with the highest credibility on the tag of the user tag list; and
forming a social network between the user and the searched user.

8. The method of claim 1, wherein said forming a social network comprises:
determining whether there is a user recommended by an administrator concerning tags of the user tag list;
forming a social network between the user and the recommended user if there is a recommended user; and
forming a social network between the user and the searched user with the highest credibility on the tag if there is no recommended user.

9. The method of claim 8, wherein the recommended user is set by an administrator as a user representing a region associated with a tag.

10. The method of claim 7 erg, wherein the credibility is computed based on a user profile.

11. The method of claim 1, wherein said forming a social network further comprises: storing social network information on the user tag list in a user information database.

12. The method of claim 1, wherein said creating a diary comprises:
determining whether there is a social network associated with a tag of the user tag list;
if there is an associated social network, acquiring contents from a user of the social network; and
linking the acquired contents to the tag of the user tag list.

13. The method of claim 12, wherein said creating a diary further comprises:
recommending discovered contents through an interne search on tags of the user tag list if there is no associated social network; and
acquiring contents selected by the user.

14. The method of claim 12, wherein the contents include texts, images, voices, and videos.

15. The method of claim 1, further comprising: storing the created diary in a user information database.

16. A system for providing a diary-based social network service (SNS), comprising:
a user terminal in which an application for a diary-based SNS is installed;
a tag collecting server creating a user tag list from tags acquired by the user terminal;
a SNS server forming a social network between a user and other users by searching through tag databases, based on the user tag list;
a diary agent communicating with the user terminal, the tag collecting server, the SNS server and the user tag list, to create a diary; and
a user information database storing the user tag list, social network information and the diary.

17. The system of claim 16, wherein the diary agent is further configured to:
receive a request for use of SNS from the user terminal;
receive a user profile from the user terminal; and
store the user profile in the user information database.

18. The system of claim 16, wherein the tag collecting server is further configured to:
receive a present location of the user terminal from the user terminal periodically; and
acquire tags classified by time and locations associated with routes of the user terminal.

19. The system of claim 16, wherein the SNS server is further configured to:
form a social network with a user recommended by an administrator concerning tags of the user tag list, based on a search of the tag database.

20. The system of claim 16, wherein the tag database is further configured to store credibility of each user on tags; and
the SNS server is further configured to form a social network with a user with the highest credibility on a tag of the user tag list, based on a search of the user tag list.

21. The system of claim 16, wherein the diary agent is further configured to:
determine if there is a social network associated with tags of the user tag list;
acquire contents from a user of the social network, if there is an associated social network; and
link the acquired contents to tags of the user tag list.

22. The system of claim 21, wherein the diary agent is further configured to:
recommend contents discovered through the Internet search on a tag of the user tag list if there is no associated social network; and
acquire contents selected by the user.

23. In a system for providing a diary-based social network service (SNS), an apparatus for forming a social network between a user and other users based on a user tag list, comprising:
means for determining whether there is a user recommended by an administrator concerning tags of the user tag list;
means for forming a social network between the user and the recommended user if there is a recommended user; and
means for forming a social network between the user and a searched user with the highest credibility on a tag if there is no recommended user.

24. In a system for providing a diary-based social network service (SNS), an apparatus for creating a diary based on a user tag list and social network information associated with tags of the user tag list, comprising:
means for determining whether there is a social network associated with a tag of the user tag list;
means for acquiring contents from a user of the social network if there is an associated social network;
means for recommending contents discovered through the internet search on a tag of the user tag list if there is no associated social network, and acquiring contents selected by the user; and
means for linking the acquired contents to tags of the user tag list.
